(19) United States
(12) Patent Application Publication
(10) Pub. No.: US 2014/0375132 A1
(43) Pub. Date: Dec. 25, 2014

(54) SMART PHOTOVOLTAIC MODULES WITH HIGH DC-AC RATIOS

(71) Applicant: SunEdison LLC, Beltsville, MD (US)

(72) Inventors: Sandeep Agarwal, Fremont, CA (US); Kartik Vasudev, Sunnyvale, CA (US); Arup Barat, Oakland, CA (US)

(21) Appl. No.: 14/310,654

(22) Filed: Jun. 20, 2014

Related U.S. Application Data
(60) Provisional application No. 61/837,509, filed on Jun. 20, 2013.

(51) Int. Cl. H02M 3/158; H02J 3/38

(52) U.S. Cl. CPC H02M 3/1588; H02J 3/38
USPC 307/63; 323/271

(57) ABSTRACT

A smart photovoltaic (PV) module includes a PV laminate configured to receive solar energy and provide a direct current (DC) power output, and a DC power manager (DCPM) electrically connected to the PV laminate to receive the DC power output of the PV laminate. The DCPM includes a DC/DC power converter configured to receive the DC power output from the PV laminate and provide a module DC power output, and a controller operatively connected to the DC/DC power converter. The controller is configured to control operation of the DC/DC power converter to produce the module DC power output at substantially the maximum power point of the PV laminate.

### CROSS REFERENCE TO RELATED APPLICATIONS

This application claims priority to U.S. patent application Ser. No. 61/837,509, filed Jun. 20, 2013, which is hereby incorporated by reference in its entirety.

### FIELD

This disclosure generally relates to photovoltaic modules, and more specifically, to smart photovoltaic modules.

### BACKGROUND

In some known solar power systems, a plurality of photovoltaic (PV) modules (also known as solar modules) are logically or physically grouped together to form an array of PV modules. Each PV module includes a PV laminate (also known as a solar laminate) that converts solar energy into electrical energy. The electrical energy may be used directly, converted for local use, and/or converted and transmitted to an electrical grid or another destination.

PV modules generally output direct current (DC) electrical power. To properly couple such PV modules to an electrical grid, or otherwise provide alternating current (AC) power, the electrical power received from the solar modules is converted from DC to AC power using a DC/AC inverter. Some known systems couple the DC output of more than one PV module to a single inverter. In some systems, an array of PV modules includes a plurality of PV modules arranged in strings of PV modules. Each string of modules is connected to a single inverter to convert the DC output of the string of PV modules to an AC output. In at least some other known systems, each PV module is coupled to its own inverter. Each inverter may be positioned near or on the PV module to which it is electrically coupled.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

According to one aspect of this disclosure, a smart photovoltaic (PV) module includes a PV laminate configured to receive solar energy and provide a direct current (DC) power output, and a DC power manager (DCPM) electrically connected to the PV laminate to receive the DC power output of the PV laminate. The DCPM includes a DC/DC power converter configured to receive the DC power output from the PV laminate and provide a module DC power output, and a controller operatively connected to the DC/DC power converter. The controller is configured to control operation of the DC/DC power converter to produce the module DC power output at substantially the maximum power point of the PV laminate.

According to another aspect of this disclosure, a photovoltaic (PV) system includes a plurality of smart PV modules and an inverter. Each smart PV module includes a PV laminate configured to receive solar energy and provide a direct current (DC) power output, and a DC power manager (DCPM) electrically connected to the PV laminate and configured to output a module DC power at substantially the maximum power point of the PV laminate. An inverter is operatively connected to the plurality of smart PV modules and configured to receive the module DC power output from the plurality of smart PV modules and output an alternating current (AC) power output.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example PV module;

FIG. 2 is a cross-sectional view of the PV module shown in FIG. 1 taken along the line A-A;

FIG. 3 is a block diagram of a smart PV module including the PV module shown in FIG. 1 and a direct current power manager (DCPM).

FIG. 4 is a block diagram of the DCPM controller shown in FIG. 3.

FIG. 5 is a simplified circuit diagram of an example synchronous buck converter for use in the DCPM shown in FIG. 4.

FIG. 6 is a graph of the power-voltage (P-V) curves of an example unshaded PV module shown in FIG. 1 for various irradiance levels.

FIG. 7 is a graph of example P-V curves produced by the smart PV module shown in FIG. 3 at various irradiance levels.

FIG. 8 is a simplified diagram of one solar cell of the smart PV module shown in FIG. 3.

FIG. 9 is a block diagram of a PV system including a plurality of the smart PV modules shown in FIG. 3.

Like reference symbols in the various drawings indicate like elements.

### DETAILED DESCRIPTION

The embodiments described herein generally relate to photovoltaic (PV) modules. More particularly, the embodiments described herein relate to PV modules with integrated power converters and PV systems including PV modules with integrated power converters.

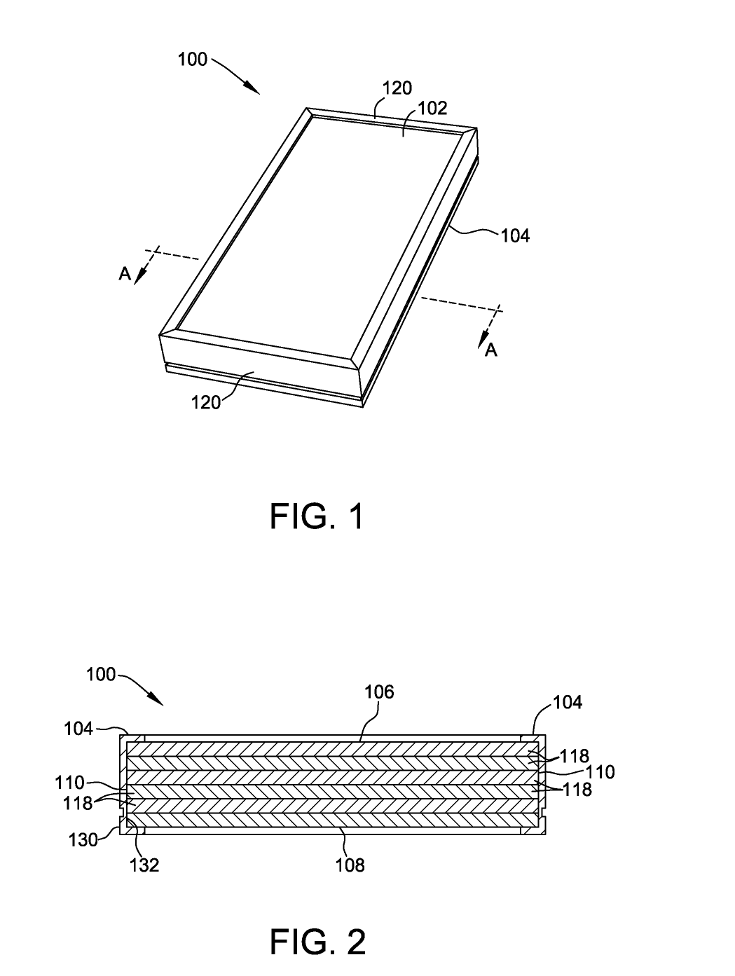

Referring initially to FIGS. 1 and 2, a PV module is indicated generally at 100. A perspective view of the PV module 100 is shown in FIG. 1. FIG. 2 is a cross sectional view of the PV module 100 taken at line A-A shown in FIG. 1. The PV module 100 includes a solar laminate 102 (also referred to as a PV laminate) and a frame 104 circumscribing the solar laminate 102.

The solar laminate 102 includes a top surface 106 and a bottom surface 108 (shown in FIG. 2). Edges 110 extend between the top surface 106 and the bottom surface 108. In this embodiment, the solar laminate 102 is rectangular shaped. In other embodiments, the solar laminate 102 may have any suitable shape.

As shown in FIG. 2, the solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer, including one, layers 118, may have different layers 118, and/or may have different types of layers 118. The solar laminate 102 includes a plurality of solar cells (not shown), each of which converts solar energy to electrical energy. The outputs of the solar cells are connected in series and/or parallel to produce the desired output voltage and current for the solar laminate 102.

As shown in FIG. 1, the frame 104 circumscribes the solar laminate 102. The frame 104 is coupled to the solar laminate 102, as best seen in FIG. 2. The frame 104 assists in protecting the edges 110 of the solar laminate 102. In this embodiment, the frame 104 is constructed of four frame members 120. In other embodiments the frame 104 may include more or fewer frame members 120.

This frame 104 includes an outer surface 130 spaced apart from solar laminate 102 and an inner surface 132 adjacent solar laminate 102. The outer surface 130 is spaced apart from and substantially parallel to the inner surface 132. In this embodiment, the frame 104 is made of aluminum. More particularly, in some embodiments the frame 104 is made of 6000 series anodized aluminum. In other embodiments, the frame 104 may be made of any other suitable material providing sufficient rigidity including, for example, rolled or stamped stainless steel, plastic, or carbon fiber.

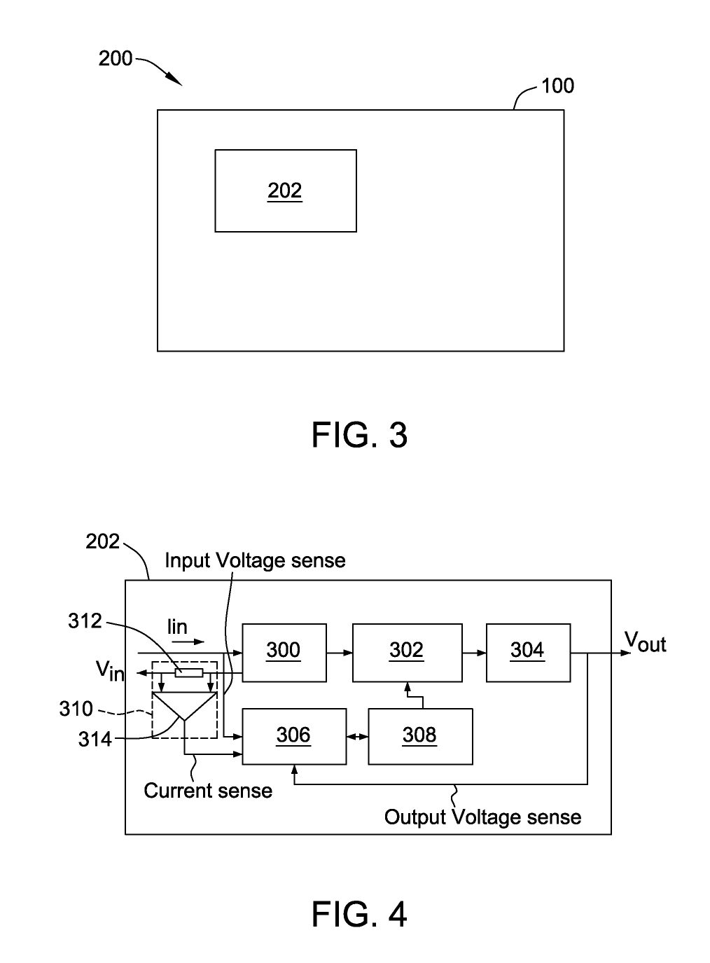

FIG. 3 is a block diagram of a smart PV module 200. The smart PV module 200 includes the PV module 100 and a direct current power manager (DCPM) 202. The DCPM 202 is included in a junction box (not shown) of the PV module 100. Alternatively, the DCPM 202 may be integrated in the solar laminate 102 or housed separately from the junction box (e.g., within a housing attached to the frame 104 or a rack supporting the module 100). Moreover, some embodiments of the smart PV module may include more than one DCPM 202, particularly when the DCPM 202 is not located inside the junction box. The DCPM 202 performs maximum power point tracking (MPPT) for the PV module 100, selectively controls (i.e., limits and/or increases) the maximum power output of the PV module 100, controls the conduction of bypass diodes (not shown) based on temperature and bypass current, and translates the output I-V curve of the PV module to a new I-V curve at which the output voltage does not vary with ambient temperature.

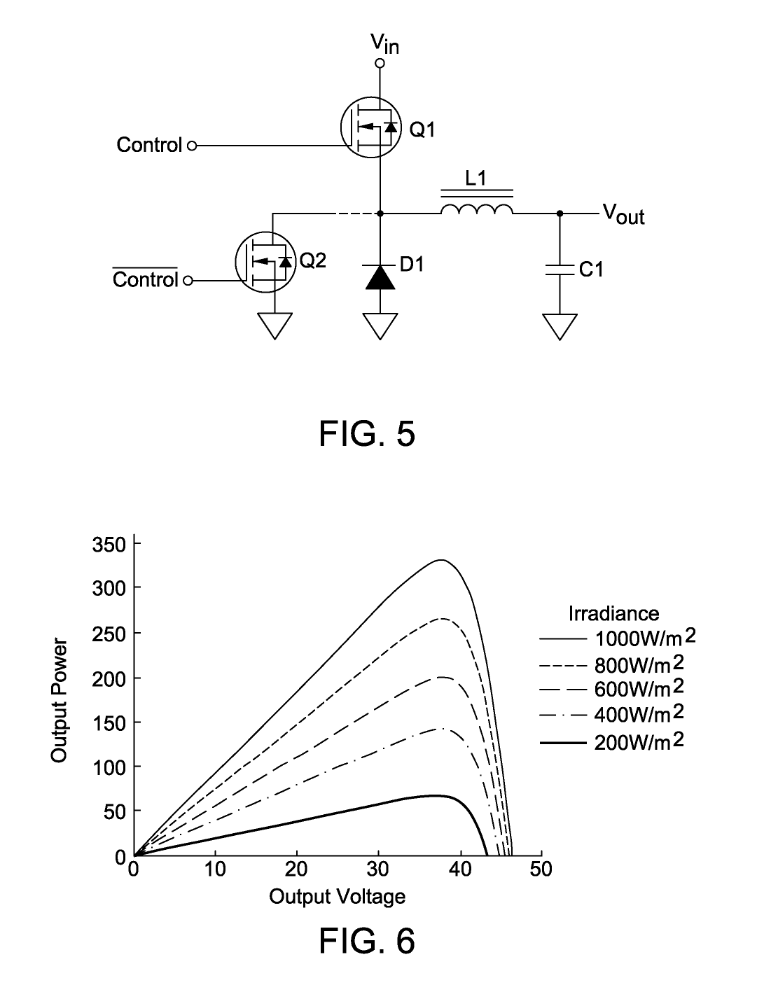

FIG. 4 is a block diagram of the DCPM 202. The DCPM 202 includes an input filter 300, a power converter 302, an output filter 304, a controller 306, a driver 308, and a current sensor 310. The current sensor 310 senses input current. Alternatively, the current sensor may additionally or alternatively sense output current and/or inductor current. The power converter 302 is a synchronous buck converter. A simplified diagram of a synchronous buck converter of one embodiment is shown in FIG. 5. Alternatively, the power converter 302 may be any suitable type of DC to DC power converter, including non-isolated and/or galvanically isolated converter topologies. In some embodiments, the power converter 302 is a boost converter or a buck-boost converter. In this embodiment, the controller 302 is a 16-bit microcontroller. Alternatively, the controller 302 may be an 8-bit microcontroller, a 32-bit microcontroller, or an ASIC. In other embodiments, the controller 306 may be any analog and/or digital controller suitable for operation as described herein. The driver 308 includes a ten volt buck converter for driving switches Q1 and Q2 (shown in FIG. 5) in the power converter 302. In this embodiment, the switches Q1 and Q2 are MOSFETS and the driver 308 is a gate driver providing control signals to drive the gates of the switches Q1 and Q2. The driver 308 includes a 10V linear voltage regulator. The current sensor 310 includes a sense resistor 312 and an amplifier 314 with an autozero function. Input current through the sense resistor 312 produces a voltage drop that is amplified by the amplifier 314 and input to the controller 306. Other embodiments may include any other suitable current sensor, including for example a current sense using Rdson of a MOSFET, the DCR of an inductor, or a Hall sensor.

The DC output of the PV module 100 is input to the DCPM 202. The input voltage and the input current sensed by the current sensor 310 are provided to the controller 306. The controller 306 uses the detected input current and voltage to determine the input power received from the PV module 100. The controller 306 determines a desired power output of the converter 302 and the smart PV module 200. Generally, the desired power output is substantially the maximum power output of the PV module (i.e. the controller 306 operates the converter 302 to provide MPPT). The controller 306 is also configured to selectively operate the converter 302 to produce an output power that is not the maximum power output of the PV module 100. The controller 306 may be configured to operate the converter to produce a relatively constant open circuit voltage regardless of changing conditions, such as changing ambient temperature, varying irradiance on the PV module 100, etc. This is unlike a conventional module that does not have a DCPM, in which both the open circuit voltage and maximum power point voltage vary substantially with temperature, irradiance, etc. Thus, the DCPM 202 may be operated to provide a substantially maximum power at a relatively fixed output voltage despite changing environmental conditions, shading, or module degradation. Alternatively, or additionally, DCPM 202 may be operated to produce a consistent power output for the smart PV module 200 across a range of output voltages, even if the consistent power output is not the maximum power output.

The controller 306 outputs to the driver 308 a pulse width modulated (PWM) signal determined to produce the desired power output. The driver 308 controls the converter 302 in accordance with the PWM signal from the controller 306 to produce the desired power output. The output voltage of the DCPM 202 is sensed and supplied as a feedback signal to the controller 306 for use in operating the power converter 302. The input filter 300 and the output filter 304 limit voltage and current ripples.

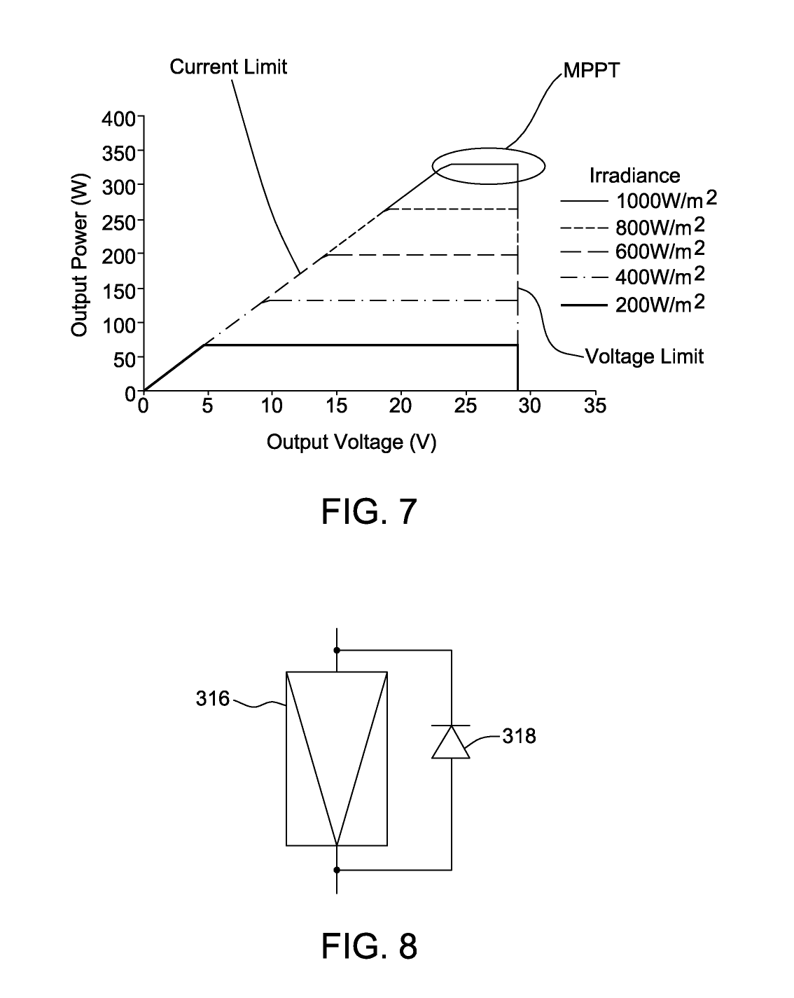

FIGS. 6 and 7 are graphs of power-voltage curves (P-V curves) of an exemplary smart PV module 200. FIG. 6 illustrates the natural P-V curves of the PV module 100 for various irradiance levels. FIG. 7 shows the P-V curves produced by the smart PV module 200 utilizing the DCPM 202 for various irradiance levels.

FIG. 8 is a simplified diagram of one solar cell 316 of the smart PV module 200. A bypass diode 318 is connected to the solar cell 316. (Alternatively, a group of solar cells 316 may be coupled to a single bypass diode 318.) The bypass diode helps protect against, for example, hot spot damage when the PV module 100 is partially shaded by snow, leaves, shadows, or other obstructions. The bypass diode 318 is connected in parallel with the solar cell 316, but with the opposite polarity. In normal operation, the bypass diode 318 is reverse biased and does not conduct. If the solar cell 316 is shaded, current through other solar cells 316 connected to the shaded cell 316 is reduced and the shaded cell 316 may become reverse biased. When the shaded solar cell 316 becomes reverse biased, the bypass diode 318 is forward biased and conducts current, thereby reducing the reverse bias on the solar cell 316. (Omission of the bypass diode 318 may lead to a large power dissipation (and increased temperature) in the shaded cell 316.) In this embodiment, the conduction of bypass diodes 318 is controlled by the controller. Typically the bypass diodes are Schottky diodes but in other embodiments, the bypass diodes may be MOSFETs. The DCPM 202 actively controls operation of the bypass diodes 318 based on temperature and bypass current to reduce losses and limit temperature increases due to shaded cell(s) 316.

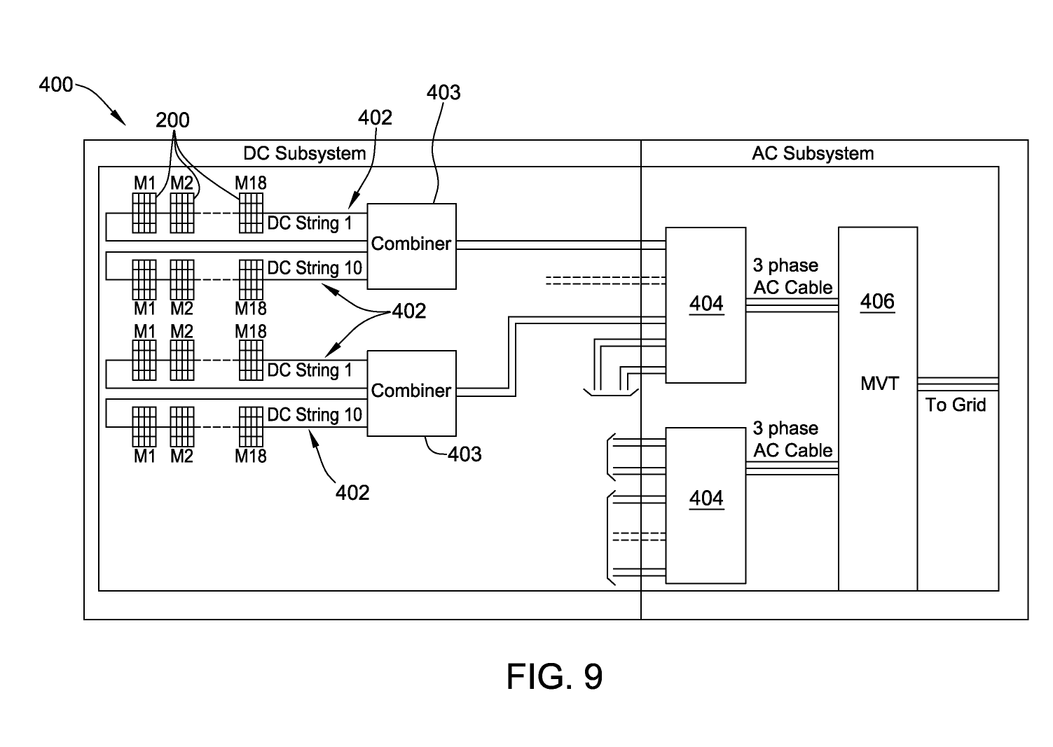

FIG. 9 is a block diagram of a PV system 400 including a plurality of smart PV modules 200. More specifically, PV system 400 includes pluralities of smart PV modules 200 connected together in strings 402. Although four strings 402 are shown, the PV system may include any suitable number of strings 402. The smart PV modules 200 in each string 402 are connected in series to provide a string output voltage greater than the output voltage of an individual smart PV module 200. Accordingly, the number of smart PV modules 200 in a string 402 may be varied to vary the output voltage of the string 402.

For example, twenty four smart PV modules (each of which provides a twenty five volt output) in a string would produce a string output voltage of six hundred volts. In this example, forty smart PV modules (each of which provides a twenty five volt output) would produce a string output voltage of one thousand volts. In other embodiments, each string 402 may include any suitable number of smart PV modules 200. The outputs of the strings 402 are input to combiner boxes 403. In the illustrated embodiment, two strings 402 are connected to each combiner box 403. Alternatively, more than two strings 402 may be connected to each combiner box 403. The outputs of the strings coupled to each combiner box 403 are combined and output to an inverter 404. The inputs to the inverter are connected in parallel. As will be obvious to those of ordinary skill in the art, varying the number of strings 402 will vary the amount of current (and power) input to the inverter 404. Further, varying the number of modules 200 in a string will vary the voltage (and power) input to the inverter 404. The inverter outputs AC power to a transformer 406, which couples the AC power to, for example, a utility grid.

In this embodiment, the inverter 404 is optimized for use with a substantially constant input voltage. Because the DCPMs 202 of the smart PV modules 200 control the open circuit voltage of each smart PV module to a substantially fixed (and known) voltage, the inverter 404 may be designed to operate at that substantially fixed voltage. The inverter 404 does not need to be configured to operate over a wide range of input voltages. Particularly, the inverter does not need to be configured to operate at wide voltage ranges due to variation of maximum power point voltage in strings with non-smart modules. This allows the use of fewer, simpler, and/or lower current rated components in the inverter 404, thereby reducing the cost of the inverter 404 and increasing its power rating.

Many known systems, including the system 400, are designed with a relatively high DC/AC ratio (i.e. the nominal DC power rating at STC is higher than the rating of the inverter) in order to minimize the levelized cost of electricity (LCOE). In some known systems, the inverter is required to operate the PV modules in the system away from the maximum power point when, for example, the DC power in the PV array exceeds the maximum power rating of the inverter or a grid operator demands power curtailment. In this embodiment, the system 400 still maintains a relatively high DC/AC power ratio. However, the DCPM 202 in each smart PV module 200 is aware of the DC/AC ratio (e.g., the DC/AC ratio is programmed into the firmware of the DCPM 202). Each DCPM 202 limits the power output of its smart PV module 200 according to the set DC/AC ratio. The DC/AC ratio may be programmed into the DCPM 202 in the factory and/or may be user selectable/programmable though a wired and/or wireless interface with the DCPM.

Moreover, because the DCPM 202 limits the power output of the smart PV module 200 according to the DC/AC ratio of the system 400, the open circuit voltage of the DCPM can be reduced by firmware for the same short circuit current setting, the short circuit current can be reduced by firmware for the same open circuit voltage setting, or a combination of the two. By reducing the open circuit voltage, an even greater number of smart PV modules 200 can be connected in a string 402. By increasing the number of smart PV modules 200 in a string 402, system 400 needs even fewer strings to accommodate the same number of modules and provide the same amount of output power. Using fewer strings 402 may reduce the amount of materials (such as combiner boxes, home run cables, DC wiring, etc.) needed to construct system 400. Systems including smart PV modules 200 typically permit 1.5 to 2 times the number of modules in a string than systems with conventional PV modules. Depending on the DC-AC ratio of the system this may be extended to 2 to 3 times the number of modules in a string than systems with conventional PV modules.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A smart photovoltaic (PV) module comprising:
a PV laminate configured to receive solar energy and provide a direct current (DC) power output; and
a DC power manager (DCPM) electrically connected to the PV laminate to receive the DC power output of the PV laminate, the DCPM comprising:
a DC/DC power converter configured to receive the DC power output from the PV laminate and provide a module DC power output; and
a controller operatively connected to the DC/DC power converter, the controller configured to control operation of the DC/DC power converter to produce the module DC power output at substantially the maximum power point of the PV laminate.

2. The smart PV module of claim 1, wherein the controller is further configured to control operation of the DC/DC power converter to provide the module output power at a substantially constant open circuit voltage when a temperature or irradiance incident on the module changes and as the module degrades.

3. The smart PV module of claim 1, wherein the controller is further configured to control operation of the DC/DC power converter to limit the module power output below a maximum power output based on a predetermined ratio of DC to alternating current (AC).

4. The smart PV module of claim 3, wherein the DCPM includes a memory device storing firmware for operation of the controller, and the predetermined DC/AC ratio is programmed into the firmware.

5. The smart PV module of claim 1, wherein the PV laminate comprises a plurality of solar cells, and further comprising at least one bypass diode coupled in parallel with at least one of the solar cells.

6. The smart PV module of claim 5, wherein the controller is further configured to control conduction of the at least one bypass diode.

7. The smart PV module of claim 6, wherein the controller is configured to control conduction of the at least one bypass diode based at least in part on a temperature of the PV laminate.

8. The smart PV module of claim 6, wherein the controller is configured to control conduction of the at least one bypass diode based at least in part on a magnitude of a current through the bypass diode.

9. The smart PV module of claim 1, wherein the controller is further configured to control operation of the DC/DC power converter to reduce the module DC power output based on a predetermined ratio.

10. The smart PV module of claim 9, wherein the predetermined ratio is determined based on a DC:AC ratio of a PV system including the smart PV module.

11. A photovoltaic (PV) system comprising:
a plurality of smart PV modules, each smart PV module comprising:
a PV laminate configured to receive solar energy and provide a direct current (DC) power output; and
a DC power manager (DCPM) electrically connected to the PV laminate and configured to output a module DC power output at substantially a maximum power point of the PV laminate; and
an inverter operatively connected to the plurality of smart PV modules, the inverter configured to receive the module DC power output from the plurality of smart PV modules and output an alternating current (AC) power output.

12. The PV system of claim 11, wherein the DCPM comprises
a DC/DC power converter configured to receive the DC power output from the PV laminate and provide a module DC power output; and
a controller operatively connected to the DC/DC power converter, the controller configured to control operation of the DC/DC power converter to produce the module DC power output at substantially the maximum power point of the PV laminate.

13. The PV system of claim 11, wherein the plurality of smart PV modules includes a first string comprising a plurality of smart PV modules having their module DC power outputs connected in series to provide a first string power output, and wherein the first string power output is input to the inverter.

14. The PV system of claim 13, wherein the plurality of smart PV modules includes a second string comprising a plurality of smart PV modules having their module DC power outputs connected in series to provide a second string power output, and wherein the second string power output is input to the inverter.

15. The PV system of claim 14, further comprising a combiner box coupled to the first string, the second string, and the inverter, wherein the first string power output and the second string power output are input to the combiner box, and a combined power output of the first and second string power outputs is input to the inverter.

16. The PV system of claim 14, wherein the first string DC power output is connected in parallel with the second string power output and input to the inverter.

17. The PV system of claim 11, wherein the inverter is configured to operate with a power input from the plurality of smart PV modules at a substantially constant voltage.

18. The PV system of claim 11, wherein the inverter has an alternating current (AC) output power rating less than a maximum DC power output of the plurality of smart PV modules.

19. The PV system of claim 18, wherein DCPM is further configured to limit its module power output below a maximum power output based on a DC/AC power ratio defined by the inverter AC output power rating and the maximum DC power output of the plurality of smart PV modules.

20. The PV system of claim 11, wherein a DC:AC ratio of the system is greater than one.

21. The PV system of claim 20, wherein the DCPM is further configured to reduce the module DC power output by a predetermined factor based at least in part on the DC:AC ratio of the system.

22. The PV system of claim 11, wherein the inverter is configured to receive the module DC power output at a substantially constant voltage.

23-29. (canceled)
